(19) United States
(12) Patent Application Publication
(10) Pub. No.: US 2014/0246865 A1
(43) Pub. Date: Sep. 4, 2014

(54) Generator Device

(71) Applicant: Mehri Mafi, San Jose, CA (US)

(72) Inventors: Mehri Mafi, San Jose, CA (US); Maryam Mafi, San Jose, CA (US)

(21) Appl. No.: 14/100,338

(22) Filed: Dec. 9, 2013

Related U.S. Application Data
(60) Provisional application No. 61/848,329, filed on Dec. 26, 2012.

(51) Int. Cl. F03G 7/00

(52) U.S. Cl. CPC F03G 7/00
USPC 290/1 R

(57) ABSTRACT

A generator device includes at least one rotary portion and an induction generator working in conjunction to generate electricity. A perpetual force, such as a stream of liquid or a heavy object, propels the rotary portion to generate electricity. Numerous rotary portions are propelled, and work in conjunction together to create a multiplier effect for increasing the quantity of electricity generated. The electricity induces the induction generator to produce additional electricity. In this manner, no gasoline is needed to run the generator device. A rechargeable battery operatively joins with the generator device to provide electricity when the rotary portion is not functional. In an educational embodiment, the device includes an at least partially transparent housing, whereby the process of electrical generation may be observed. The rotary portions and the housing have various colors.

### CROSS-REFERENCE TO RELATED APPLICATIONS

The present Utility patent application claims priority benefit of the U.S. provisional application for patent Ser. No. 61/848,329 titled “Portable Generator,” filed on Dec. 26, 2012 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a generator device. More particularly, the invention relates to a generator device that .

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that an electric generator is a device that converts mechanical energy to electrical energy. A generator forces electric current to flow through an external circuit. The source of mechanical energy may be a reciprocating or turbine steam engine, water falling through a turbine or waterwheel, an internal combustion engine, a wind turbine, a hand crank, compressed air, or any other source of mechanical energy.

It is known that the reverse conversion of electrical energy into mechanical energy is done by an electric motor, and motors and generators have many similarities. Many motors can be mechanically driven to generate electricity and frequently make acceptable generators.

Typically, electromagnetic induction is the production of a potential difference across a conductor when it is exposed to a varying magnetic field. Inductive electrical generation often requires a spark of voltage from another electrical source to commence generating additional electricity.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B illustrate detailed perspective views of exemplary generators, where FIG. 1A illustrates an exemplary rotary generator, and FIG. 1B illustrates an exemplary induction generator, in accordance with an embodiment of the present invention;

FIGS. 2A and 2B illustrate sectioned views of exemplary generator devices, where FIG. 2A illustrates an exemplary rotary generator, and FIG. 2B illustrates an exemplary plurality of rotary portions working in conjunction to generate electricity, in accordance with an embodiment of the present invention; and

FIG. 3 illustrates a sectioned side view of an exemplary rotary device where an exemplary at least one rotary portion is being struck by an exemplary force to generate electricity, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

The present invention will now be described in detail with reference to embodiments thereof as illustrated in the accompanying drawings.

There are various types of generator devices that may be provided by preferred embodiments of the present invention. In one embodiment of the present invention, the generator device may utilize a mechanical rotary mechanism to generate electricity with at least one rotary portion, and then harness some of the generated electricity to produce additional electricity through an electromagnetic induction generator. In some embodiments, numerous rotary portions may work in conjunction together to create a multiplier effect for increasing the quantity of electricity generated. Those skilled in the art, in light of the present teachings, will recognize that an induction generator must be excited with a leading voltage to generate electricity. The leading voltage, in this case, may be generated by the at least one rotary portion. The generator device may utilize more than one rotary portion to generate the electricity, whereby more rotary portions rotating in conjunction generate more electricity. The plurality of rotary portions may interlock while rotating to provide a multiplier effect and push each other, similar to a gear assembly. In this manner, the generator device may not require an independent source of energy, such as gasoline to operate in normal conditions. However, a rechargeable battery may operatively join with the generator device to provide electricity when the rotary portion is not functional. In some embodiments, the generator device may enhance an educational aspect by having an at least partially transparent housing, whereby the process of electrical generation may be observed.

In one embodiment of the present invention, the generator device may convert mechanical motions into electricity by rotating at least one rotary portion through perpetual means. A force from a heavy object, such as sand, water, or air may provide this force. In this manner, the generator device may not require gasoline to operate. The at least one rotary portion may include a plurality of paddle wheels, whereby a greater number of paddle wheels may work to generate larger quantities of electricity. In some embodiments, the rotary portion may include a paddle wheel configured to rotate when a force strikes a surface. The rotation of the paddle wheel may generate electricity, and operatively join with an outer circuitry to distribute the electricity accordingly. The paddle wheel may be rotated by a force that engages a surface on the paddle wheel, such as an object pressing against the paddle wheel to create the rotary motion. The object may include a blower dispersing a fluid on the paddle wheel to rotate the rotary portion. However, in other embodiments, additional sources of mechanical energy used to rotate the rotary portion may include, without limitation, a reciprocating or turbine steam engine, water falling through a turbine or waterwheel, an internal combustion engine, a wind turbine, a hand crank, and compressed air. The fluid may include, without limitation, water, air, sand, and marbles.

In some embodiments, the generator device may further include an induction generator. The electricity harnessed by the rotary portion may induce the induction generator by mechanically turning an induction rotary portion faster than the synchronous speed, thereby giving negative slip in the induction rotary portion to generate an alternating current. Those skilled in the art will recognize that the induction generator may recover energy with relatively simple controls. This simplicity may be useful for the present invention because of the few moving parts and wiring involved. The generator device may provide an educational aspect by having a housing that is at least partially transparent for enabling viewing of the at least one rotary portion.

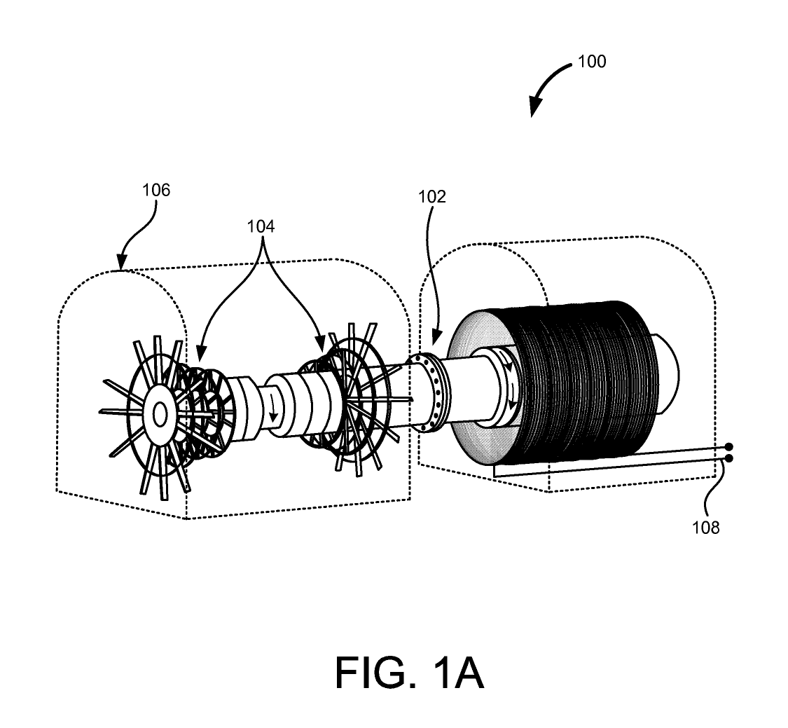

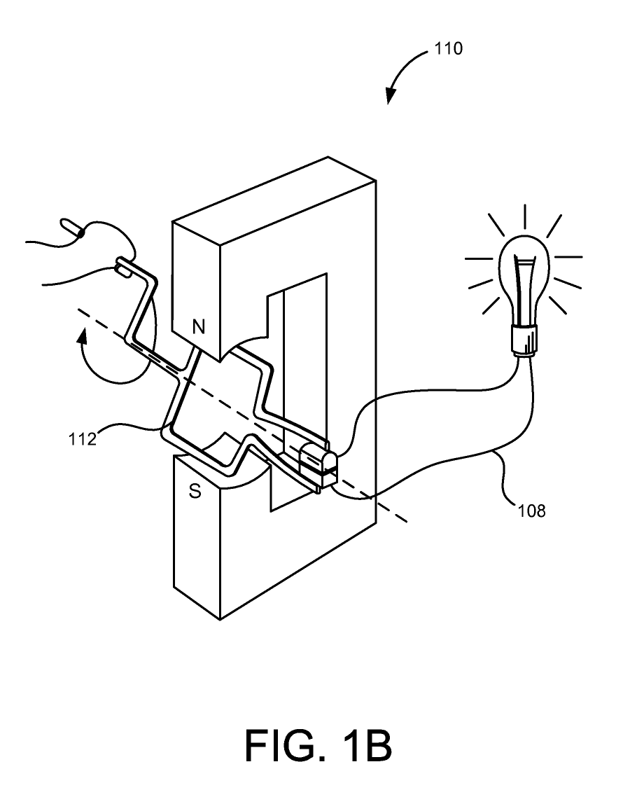

FIGS. 1A and 1B illustrate detailed perspective views of exemplary generators, where FIG. 1A illustrates an exemplary rotary generator, and FIG. 1B illustrates an exemplary induction generator, in accordance with an embodiment of the present invention. In the present invention, a generator device 100 may utilize a mechanical rotary mechanism to generate electricity with at least one rotary portion 102, and then harness some of the generated electricity to produce additional electricity through an electromagnetic induction generator 110. In some embodiments, numerous rotary portions may work in conjunction together to create a multiplier effect for increasing the quantity of electricity generated.

In some embodiments, a force from an object, such as air, water, marbles, or sand may propel a paddle wheel 104 on each rotary portion to create the rotary movement necessary for generating electricity in the generator device. Those skilled in the art will recognize that an induction generator must be excited with a leading voltage to generate electricity. The leading voltage, in this case, may be generated by the at least one rotary portion. The generator device may utilize more than one rotary portion to generate the electricity, whereby more rotary portions rotating in conjunction generate more electricity. The rotation of the paddle wheel may generate electricity, and operatively join with an outer circuitry 108 to distribute the electricity accordingly. Each rotary portion and paddle wheel may have various colors, and lighting, including, without limitation, light emitting diodes, bulbs, and reflector tape.

In some embodiments, the generator device may utilize the induction generator to generate additional electricity. The electricity harnessed by the rotary portion may induce the induction generator by mechanically turning an induction rotary portion 112 faster than the synchronous speed, thereby giving negative slip in the induction rotary portion to generate an alternating current. Those skilled in the art will recognize that the induction generator may recover energy with relatively simple controls. This simplicity may be useful for the present invention because of the few moving parts and wiring involved.

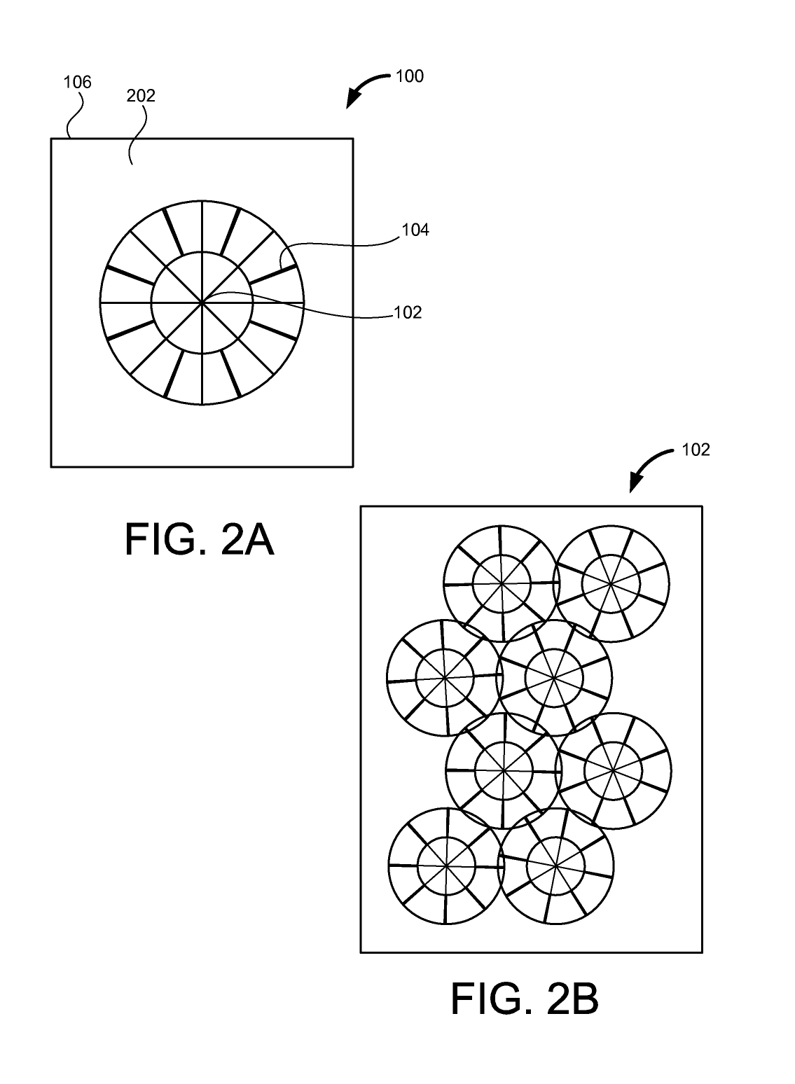

FIGS. 2A and 2B illustrate sectioned views of exemplary generator devices, where FIG. 2A illustrates an exemplary rotary generator, and FIG. 2B illustrates an exemplary plurality of rotary portions working in conjunction to generate electricity, in accordance with an embodiment of the present invention. In the present invention, the generator device may utilize more than one rotary portion to generate the electricity, whereby more rotary portions rotating in conjunction generate more electricity. The plurality of rotary portions may interlock while rotating to provide a multiplier effect and push each other, similar to a gear assembly. In this manner, the generator device may not require an independent source of energy, such as gasoline to operate in normal conditions.

In one embodiment, the generator device may convert mechanical motions into electricity by rotating at least one rotary portion through perpetual means. The at least one rotary portion may include a plurality of paddle wheels, whereby a greater number of paddle wheels may work to generate larger quantities of electricity. In some embodiments, the rotary device may be protected by a housing 106. In some embodiments, the generator device may enhance an educational aspect by having an at least partially transparent housing, whereby the process of electrical generation may be observed through a transparent portion 202, such as a window. The housing may have various colors, and may be shaped and dimensioned to enable functionality by the rotary portion and the induction generator.

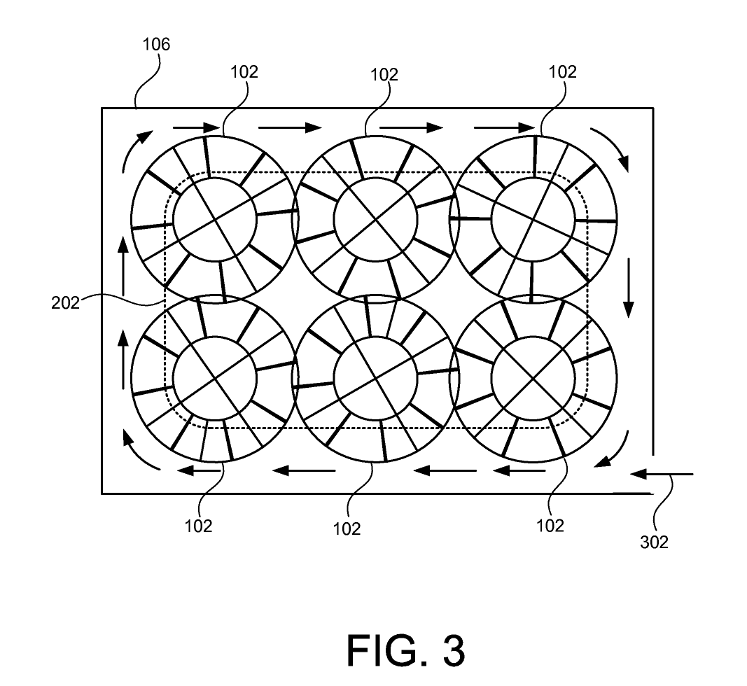

FIG. 3 illustrates a sectioned side view of an exemplary rotary device where an exemplary at least one rotary portion is being struck by an exemplary force to generate electricity, in accordance with an embodiment of the present invention. In the present invention. The generator device may utilize more than one rotary portion to generate the electricity, whereby more rotary portions rotating in conjunction generate more electricity. The plurality of rotary portions may interlock while rotating to provide a multiplier effect and push each other, similar to a gear assembly. A perpetual force 302 from an object may propel the paddle wheel. In this manner, the generator device may not require an independent source of energy, such as gasoline to operate in normal conditions. However, a rechargeable battery may operatively join with the generator device to provide electricity when the rotary portion is not functional.

In some embodiments, the rotary portion may include a paddle wheel configured to rotate when a force strikes a surface of the rotary portion. The rotation of the paddle wheel may generate electricity, and operatively join with an outer circuitry to distribute the electricity accordingly. The paddle wheel may be rotated by the perpetual force that engages a surface on the paddle wheel, such as an object pressing against the paddle wheel to create the rotary motion. The object may include a blower dispersing a fluid on the paddle wheel to rotate the rotary portion. However, in other embodiments, additional sources of mechanical energy used to rotate the rotary portion may include, without limitation, a reciprocating or turbine steam engine, water falling through a turbine or waterwheel, an internal combustion engine, a wind turbine, a hand crank, and compressed air. The fluid may include, without limitation, water, air, sand, and marbles.

In one alternative embodiment, additional types of generators may be utilized to increase the kilowatts of electricity produced, and also produce an alternating current. In yet another alternative embodiment, the housing is completely transparent and includes text to explain the inner workings of the rotary device. In yet another alternative embodiment, the object used to strike the paddle wheel is a vacuum that pulls, rather than pushes the paddle wheel.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112 (6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of generating electricity with a portable, transparent generator that utilizes multiple types of generators according to the present invention will be apparent to those skilled in the art. Various aspects of the invention have been described above by way of illustration, and the specific embodiments disclosed are not intended to limit the invention to the particular forms disclosed. The particular implementation of the generating electricity with a portable, transparent generator that utilizes multiple types of generators may vary depending upon the particular context or application. By way of example, and not limitation, the generating electricity with a portable, transparent generator that utilizes multiple types of generators described in the foregoing were principally directed to a generator with multiple rotary devices working together like gears, and having different colors that are rotated by an object striking a paddle wheel implementations; however, similar techniques may instead be applied to generators on alluvial bodies and waterfalls for tourists to view, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A device comprising:
at least one rotary portion, said at least one rotary portion being configured to at least partially receive a perpetual force, said perpetual force comprising at least one object striking a rotary portion surface, said perpetual force being operable to rotate said at least one rotary portion for generating electricity;
an induction generator, said induction generator being configured to at least partially receive said electricity from said at least one rotary portion, said induction generator being configured to generate an additional electricity; and
a housing, said housing being configured to at least partially cover said device, said housing being comprising an at least partially transparent surface for enabling viewing of said at least one rotary portion and said induction generator.

2. The device of claim 1, in which said at least one rotary portion comprises a paddle wheel.

3. The device of claim 2, wherein said paddle wheel is configured to rotate in response to said perpetual force.

4. The device of claim 3, in which said at least one rotary portion comprises a plurality of colors.

5. The device of claim 4, in which said induction generator is operable to harness said electricity for generating said additional electricity.

6. The device of claim 5, in which said induction generator comprises an induction rotary portion.

7. The device of claim 6, in which said housing comprises a plurality of colors.

8. The device of claim 7, in which said device generates electricity in an aquarium.

9. The device of claim 8, wherein said device joins with an outer circuitry for distributing said electricity and said additional electricity.

10. A device comprising:
means for joining said device with an outer circuitry;
means for applying a perpetual force on at least one rotary portion;
means for rotating said at least one rotary portion;
means for generating electricity;
means for inducing an induction generator with said electricity;
means for rotating an induction rotary portion;
means for generating an additional electricity; and
means for viewing said at least one rotary portion and said induction generator through an at least partially transparent housing.

11. A device consisting of:
at least one rotary portion, said at least one rotary portion being configured to at least partially receive a perpetual force, said perpetual force comprising at least one object striking a rotary portion surface, said perpetual force being operable to rotate said at least one rotary portion for generating electricity, said paddle wheel being configured to rotate in response to said perpetual force, said at least one rotary portion comprises a paddle wheel, said at least one rotary portion further comprising a plurality of colors;
an induction generator, said induction generator being configured to at least partially receive said electricity from said at least one rotary portion, said induction generator being configured to generate an additional electricity, said induction generator being operable to harness said electricity for generating said additional electricity, said induction generator comprising an induction rotary portion; and
a housing, said housing being configured to at least partially cover said device, said housing being comprising an at least partially transparent surface for enabling viewing of said at least one rotary portion and said induction generator, said housing comprising a plurality of colors.
